(19) United States
(12) Patent Application Publication
(10) Pub. No.: US 2020/0276084 A1
(43) Pub. Date: Sep. 3, 2020

(54) USER ACTUATED LIQUID DRUG TRANSFER DEVICES FOR USE IN READY-TO-USE (RTU) LIQUID DRUG TRANSFER ASSEMBLAGES

(71) Applicant: West Pharma. Services IL, Ltd., Ra'anana (IL)

(72) Inventor: Igor DENENBURG, Gedera (IL)

(21) Appl. No.: 16/494,974

(22) PCT Filed: Mar. 23, 2018
(86) PCT No.: PCT/IL2018/050336

§ 371 Date: Sep. 17, 2019

(30) Foreign Application Priority Data
Mar. 29, 2017 (IL) 251458

(51) Int. Cl. A61J 1/20

(52) U.S. Cl. CPC A61J 1/2089; A61J 1/2058; A61J 1/2048; A61J 1/2013

(57) ABSTRACT

Liquid drug transfer device for use in a Ready-To-Use liquid drug transfer assemblage for establishing flow communication between a liquid source and an injection vial. The liquid drug transfer device includes an injection vial adapter for mounting on an intact injection vial having an injection vial stopper without puncturing same, a liquid source adapter for attachment to a liquid source, a dual ended liquid transfer member for flow communication with the liquid source and puncturing an injection vial stopper, a safety catch mechanism requiring an initial manual linear sliding extension for priming the liquid drug transfer device, an extension limit arrangement for limiting the linear sliding extension, and a snap fit securing arrangement for securing the liquid source adapter on the injection vial adapter after actuation.

### FIELD OF THE INVENTION

The invention relates to liquid drug transfer devices suitable for use in Ready-To-Use (RTU) liquid drug transfer assemblages.

### BACKGROUND OF THE INVENTION

Ready-To-Use (RTU) liquid drug transfer assemblages include a liquid drug transfer device and at least one intact non-punctured injection vial attached thereto. Such RTU assemblages require a user actuation for puncturing an injection vial for enabling flow communication therewith. Such RTU assemblages can be generally classified into two types as follows: First, a liquid drug transfer device with a user removable injection vial. The liquid drug transfer device can be supplied with a pre-attached injection vial or alternatively a user attaches same in a telescopic snap fit mounting action as a prior step to user actuation for puncturing. And second, a liquid drug transfer device with an irremovable injection vial except by applying extreme force damaging the liquid drug transfer device and/or the injection vial. Such RTU arrangements are particularly beneficial for wide range of usage environments including inter alia home use, out-patient clinic use, and the like.

Commonly owned PCT International Application No. PCT/IL2010/000777 entitled Vial Assemblage with Vial and Pre-Attached Fluid Transfer Device and published under PCT International Publication No. WO 2011/039747 discloses RTU assemblages of the first type. The RTU assemblages include a fluid transfer device having a pre-attached removable injection vial for use with a needleless syringe. The fluid transfer devices include an elongated tubular flow member having a connector for sealing flow communication with a needleless syringe and a puncturing cannula for puncturing an injection. The puncturing cannula tip is embedded in an injection vial stopper. WO 2011/039747 FIG. 9 to FIG. 13 disclose a fluid transfer device with a pull ring type safety catch mechanism. WO 2011/039747 FIG. 14 to FIG. 23 disclose a fluid transfer device with a twist and depress safety catch mechanism.

Commonly owned PCT International Application No. PCT/IL2013/050721 entitled Liquid Drug Transfer Devices employing Manual Rotation for Dual Flow Communication Step Actuations and published under PCT International Publication No. WO 2014/033710 discloses RTU assemblages of both types for enabling flow communication between an injection vial and a liquid source in the form of another injection vial, an infusion liquid container, and the like. The RTU assemblages include liquid drug transfer devices employing different mechanical arrangements for converting manual rotation into a linear displacement for flow communication purposes. Suitable mechanical arrangements include inter alia a screw thread arrangement, a pin and track arrangement, and the like.

Commonly owned PCT International Application No. PCT/IL2014/050327 entitled Drug Container Closure for Mounting on Open-topped Drug Container to form Drug Reconstitution Assemblage for use with Needleless Syringe and published under PCT International Publication No. WO 2014/170888 discloses RTU assemblages of the second type for use with a needleless syringe. The RTU assemblages include a fluid transfer member with an integral needleless syringe connector and a puncturing cannula. The fluid transfer member is manually disposed along a diametric inverted L-shaped track pair from an initial non-puncturing position to a puncturing position. The inverted L-shaped track pair includes one-way snap fit members to prevent a user returning the fluid transfer member to an earlier position and indicating progress of the user activation.

### SUMMARY OF THE INVENTION

The present invention is directed towards liquid drug transfer devices for use in Ready-To-Use (RTU) liquid drug transfer assemblages. The liquid drug transfer devices include an injection vial adapter for telescopic mounting on a non-punctured injection vial having an injection vial stopper and an uppermost injection vial surface without puncturing same. An injection vial adapter can be designed to either enable or prevent removal of an injection vial. The liquid drug transfer devices include a liquid source adapter intended for flow communication with a range of liquid sources. Suitable liquid sources include inter alia a needleless syringe with a male connector, an infusion liquid container, and the like.

A liquid source adapter is mounted on an injection vial adapter and configured for telescopically receiving the injection vial adapter therein on a manual linear sliding compaction of a liquid drug transfer device from an initial pre-actuated height H1 to a final actuated height H2 where H2<H1. The liquid drug transfer devices each include a dual ended liquid transfer member with a puncturing tip for puncturing an injection vial stopper. A dual ended liquid transfer member can be either integral formed with a liquid source adapter or a discrete component interdisposed between a liquid source adapter and an injection vial adapter depending on an intended liquid source. The puncturing tip is deployed above an uppermost injection vial surface in a pre-actuated state of a liquid drug transfer device and punctures through the injection vial stopper in the actuated state.

The liquid drug transfer devices include an integral safety catch mechanism for precluding inadvertent user actuation leading to inadvertent puncturing an intact non-punctured injection vial. The safety catch mechanism requires an initial manual linear sliding extension for imparting a short extension of the liquid source adapter from the injection vial adapter for priming the liquid drug transfer device ready for a subsequent manual linear sliding compaction whereupon the liquid source adapter snugly receives the injection vial adapter therein. The compaction stroke is necessarily longer than the extension stroke because the compaction stroke includes causing the puncturing tip to puncture the injection vial stopper. The liquid drug transfer devices include an extension limit arrangement for limiting the extension of the liquid source adapter from the vial injection adapter on priming the safety catch mechanism from its initial pre-actuated state. The liquid drug transfer device includes a snap fit securing arrangement for securing the liquid source adapter on the injection vial adapter in the actuated state.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a front elevation view of a Ready-To-Use (RTU) liquid drug transfer assemblage including a first embodiment of a user actuated liquid drug transfer device in a pre-actuated state and a pre-attached user removable injection vial;

FIG. 2 is a top plan view of FIG. 1's RTU liquid drug transfer assemblage;

FIG. 3 is an exploded view of FIG. 1's liquid drug transfer device;

FIG. 4 is a longitudinal cross section of an injection vial of FIG. 1's RTU liquid drug transfer assemblage;

FIG. 5 is a longitudinal cross section of FIG. 1's RTU liquid drug transfer assemblage including its liquid drug transfer device in a pre-actuated state along line A-A in FIG. 2;

FIG. 6 is a longitudinal cross section of FIG. 1's RTU liquid drug transfer assemblage including its liquid drug transfer device in a pre-actuated state along line B-B in FIG. 2;

FIG. 7 is a close up view of the encircled area A in FIG. 6;

FIG. 8 is a longitudinal cross section of FIG. 1's RTU liquid drug transfer assemblage including its liquid drug transfer device in an intermediate primed state along line A-A in FIG. 2;

FIG. 9 is a longitudinal cross section of FIG. 1's RTU liquid drug transfer assemblage including its liquid drug transfer device in its intermediate primed state along line B-B in FIG. 2;

FIG. 10 is a close up view of the encircled area B in FIG. 9;

FIG. 11 is a close up view showing non engagement of the safety catch mechanism on compaction of FIG. 1's liquid drug transfer device from its intermediate primed state towards its actuated state;

FIG. 12 is a longitudinal cross section of FIG. 1's RTU liquid drug transfer assemblage including its liquid drug transfer device in an actuated state along line A-A in FIG. 2;

FIG. 13 is a longitudinal cross section of FIG. 1's RTU liquid drug transfer assemblage including its liquid drug transfer device in an actuated state along line B-B in FIG. 2;

FIG. 14 is a front elevation view of a Ready-To-Use (RTU) liquid drug transfer assemblage including a second embodiment of a user actuated liquid drug transfer device in a pre-actuated state and a pre-attached injection vial and an infusion bag;

FIG. 15 is a top plan view of FIG. 14's RTU liquid drug transfer assemblage;

FIG. 16 is an exploded view of FIG. 14's liquid drug transfer device;

FIG. 17 is a longitudinal cross section of FIG. 14's RTU liquid drug transfer assemblage in a pre-actuated state along line C-C in FIG. 15;

FIG. 18 is a longitudinal cross section of FIG. 14's RTU liquid drug transfer assemblage in a pre-actuated state along line D-D in FIG. 15;

FIG. 19 is a longitudinal cross section of FIG. 14's RTU liquid drug transfer assemblage in an intermediate primed state along line C-C in FIG. 15;

FIG. 20 is a longitudinal cross section of FIG. 14's RTU liquid drug transfer assemblage in its intermediate primed state along line D-D in FIG. 15;

FIG. 21 is a longitudinal cross section of FIG. 14's RTU liquid drug transfer assemblage in an actuated state along line C-C in FIG. 15 in flow communication with the infusion bag;

FIG. 22 is a longitudinal cross section of FIG. 14's RTU liquid drug transfer assemblage in an actuated state along line D-D in FIG. 15 in flow communication with the infusion bag;

FIG. 23 is a front perspective view of a third embodiment of a user actuated liquid drug transfer device in a pre-actuated state;

FIG. 24 is a longitudinal cross section of FIG. 23's liquid drug transfer device in an intermediate primed state; and

FIG. 25 is a longitudinal cross section of FIG. 23's liquid drug transfer device in an actuated state.

### DETAILED DESCRIPTION OF PREFERRED EMBODIMENTS OF THE INVENTION

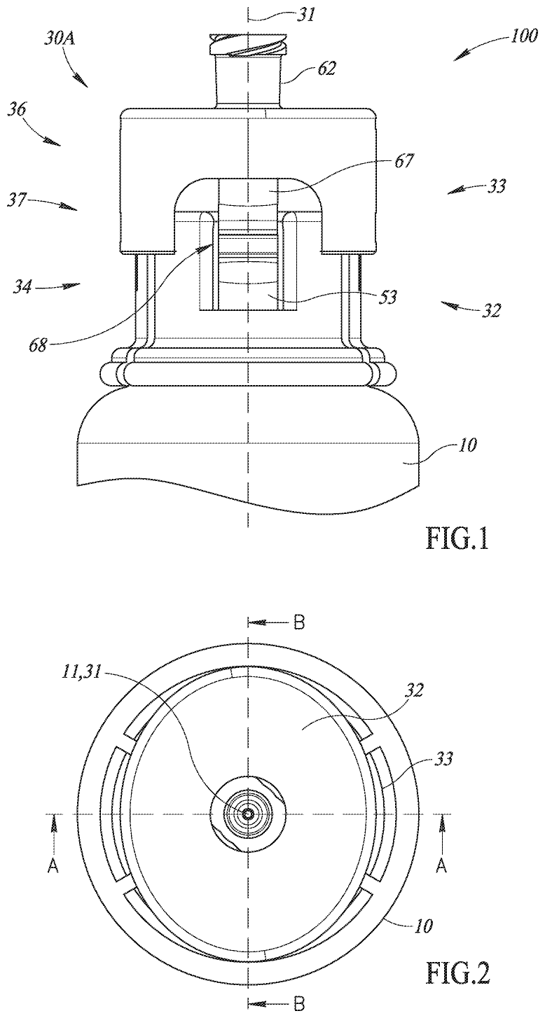

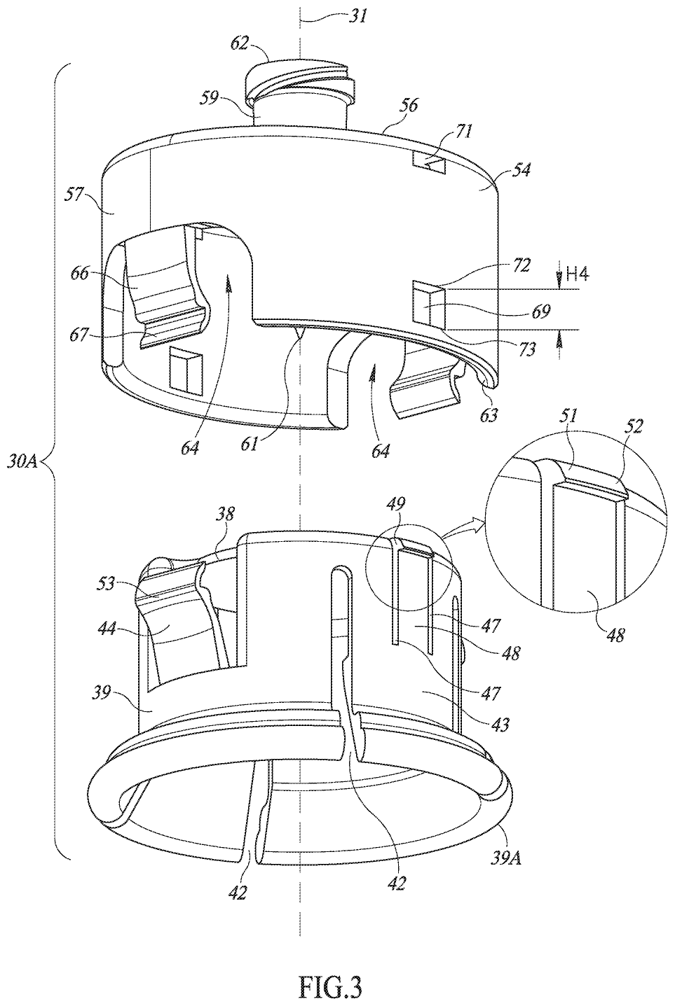

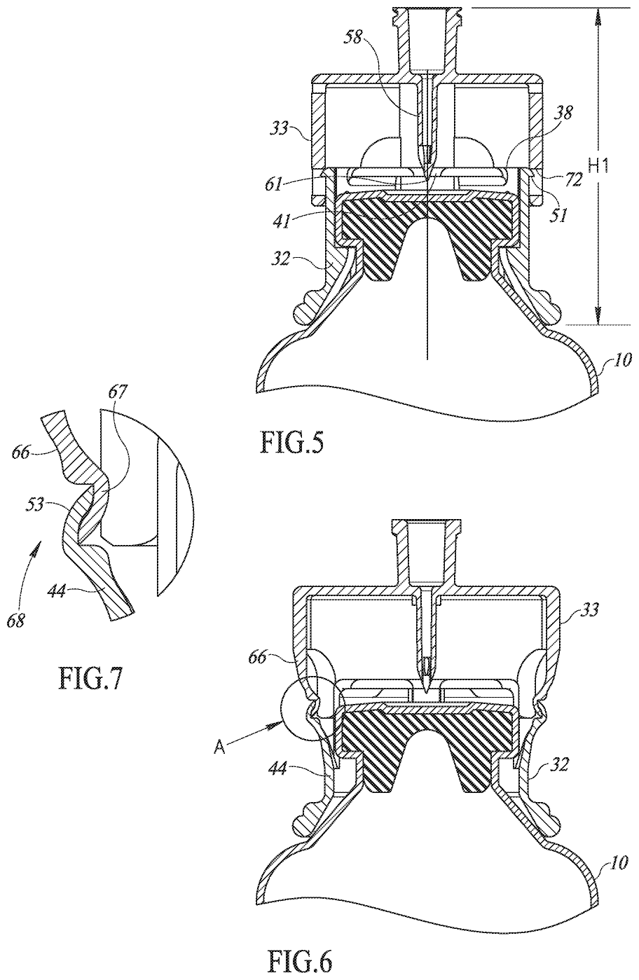

FIG. 1 to FIG. 7 show a Ready-To-Use (RTU) liquid drug transfer assemblage 100 including a user actuated liquid drug transfer device 30A in a pre-actuated state and a pre-attached injection vial 10. The injection vial 10 has a longitudinal injection vial centerline 11 and includes a closed end vial tube 12, a tubular vial crown 13 having a crown opening 14 and a vial neck 16 intermediate the vial tube 12 and the vial crown 13. The injection vial 10 includes a vial shoulder 17 intermediate the vial tube 12 and the vial neck 16. The injection vial 10 includes an injection vial stopper 18 stopping the crown opening 14 and an uppermost injection vial surface 19. The injection vial 10 can include powder contents requiring reconstitution to form a liquid drug. Alternatively, the injection vial 10 can include liquid contents requiring dilution for administration purposes.

The liquid drug transfer device 30A has a longitudinal device centerline 31 and includes an injection vial adapter 32 for telescopic snap fit mounting on the injection vial 10 and a liquid source adapter 33 initially mounted on the injection vial adapter 32 in a pre-actuated state. The liquid drug transfer device 30A includes a safety catch mechanism 34 for priming the liquid drug transfer device 30A ready for actuation thereby preventing inadvertent user actuation to puncture the intact non-punctured injection vial 10. The liquid drug transfer device 30A includes an extension limit arrangement 36 for limiting linear sliding extension of the liquid source adapter 33 from the vial injection adapter 32 on priming the liquid drug transfer device 30A. The liquid drug transfer device 30A includes a snap-fit securing arrangement 37 for securing the liquid source adapter 33 on the injection vial adapter 32 in an actuated state.

The injection vial adapter 32 includes a transverse injection vial adapter top surface 38 and a downward depending injection vial adapter skirt 39 for telescopic mounting on the vial crown 13. The downward depending injection vial adapter skirt 39 has a lowermost injection vial adapter skirt rim 39A. The injection vial adapter top surface 38 has a throughgoing injection vial adapter top surface aperture 41 overlying the uppermost injection vial surface 19. The injection vial adapter skirt 39 includes four longitudinal slits 42 forming a diametric resiliently flexible flex member pair 43. The injection vial adapter skirt 39 includes a diametric resiliently flexible longitudinal directed flex member pair 44 orthogonal to the flex member pair 43.

The flex member pair 43 each includes an inward directed protrusion 46 for snap fit under the vial crown 13. The flex member pair 43 each includes a longitudinal slit pair 47 forming a central longitudinal directed flex securing member 48 constituting a component of both the extension limit arrangement 36 and the snap fit securing arrangement 37. The flex securing members 48 each have a free end 49 flush with the injector vial adapter top surface 38. The free ends 49 are formed with an outward directed protrusion 51 having an inclined leading surface 52.

The diametric resiliently flexible longitudinal directed flex member pair 44 terminate at an inward directed hook 53 disposed toward the injection vial adapter top surface 38.

The liquid source adapter 33 includes a cap-like member 54 having a transverse liquid source adapter top surface 56 and a downward depending liquid source adapter skirt 57 for telescopically receiving the injection vial adapter 32 therein in an actuated state of the liquid drug transfer device 30A. The liquid source adapter 33 includes an integral dual ended liquid transfer member 58 having an upward liquid transfer member end 59 and terminating in a downward puncturing tip 61 for puncturing the injection vial stopper 18 for flow communication with the vial tube 12. The upward liquid transfer member end 59 is constituted by an upright liquid drug access port 62 protruding from the liquid source adapter top surface 56. The liquid drug access port 62 is preferably constituted by a female connector as shown for flow communication with a needleless syringe, a male connector, and the like.

The liquid source adapter skirt 57 has a lowermost liquid source adapter skirt rim 63 and is formed with a diametric cutaway pair 64 each with a resiliently flexible longitudinal directed flex member 66 terminating at an outward directed hook 67 adjacent with the liquid source adapter skirt rim 63. The safety catch mechanism 34 includes a diametric safety catch pair 68 each being constituted by an inward directed hook 53 and an outward directed hook 67.

The liquid source adapter skirt 57 includes a diametric extension limit aperture pair 69 adjacent the liquid source adapter skirt rim 63 and a diametric securing aperture pair 71 adjacent the liquid source adapter top surface 56. The extension limit aperture pair 69 each has an uppermost transverse rim 72 and a lowermost transverse rim 73.

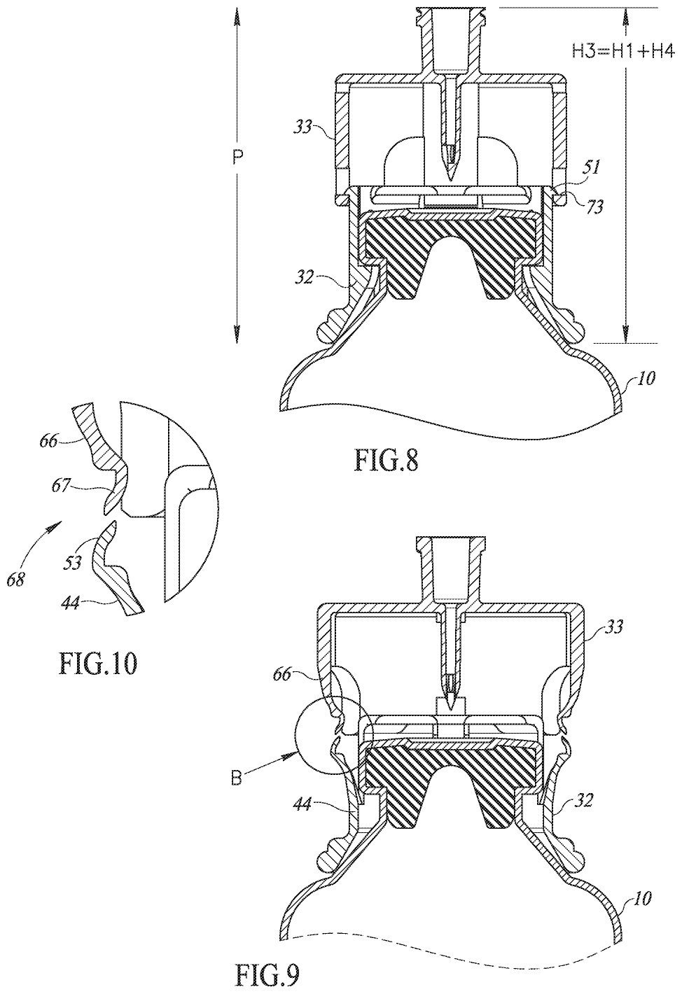

The heights of the liquid drug transfer device 30A at its three different states: pre-actuated state, intermediate primed state and actuated state are indicated between the female connector 62 and the lowermost injection vial adapter skirt rim 39A. Accordingly, the liquid drug transfer device 30A has a pre-actuated height H1 (see FIG. 5) greater than its actuated height H2 (see FIG. 12). The liquid drug transfer device 30A has an intermediate primed height H3 (see FIG. 8) greater than its pre-actuated height H1 wherein H3=H1+H4 and H4 is the height of the extension limit aperture pair 69.

FIG. 5 to FIG. 13 show use of the liquid drug transfer device 30A is as follows:

FIG. 5 to FIG. 7 show the liquid drug transfer device 30A in a pre-actuated state at a height H1. The puncturing tip 61 overlies the uppermost injection vial surface 19. The outward directed protrusion pair 51 are deployed at the uppermost transverse rim pair 72. The flex member pair 44 are outwardly biased with respect to their non-flexed positions and the flex member pair 66 are inwardly biased with respect to their non-flexed positions such that the safety catch pair 68 are engaged. Accordingly, the safety catch mechanism 34 is operative for preventing an inadvertent user compaction of the liquid source adapter 33 towards the injection vial adapter 32 until after the priming of the liquid drug transfer device 30A.

FIG. 8 to FIG. 10 show the liquid drug transfer device 30A in an intermediate primed state at the primed height H3 by virtue of an initial manual linear sliding extension denoted P for extending the liquid source adapter 33 from the injection vial adapter 32 being stopped by the outward directed protrusion pair 51 stopping against the lowermost transverse rim pair 73. The manual linear sliding extension disengages the inward directed hook pair 53 and the outward directed hook pair 67 such that the flex member pair 44 and flex member pair 66 assume their non-flex positions, thereby releasing the safety catch mechanism 34.

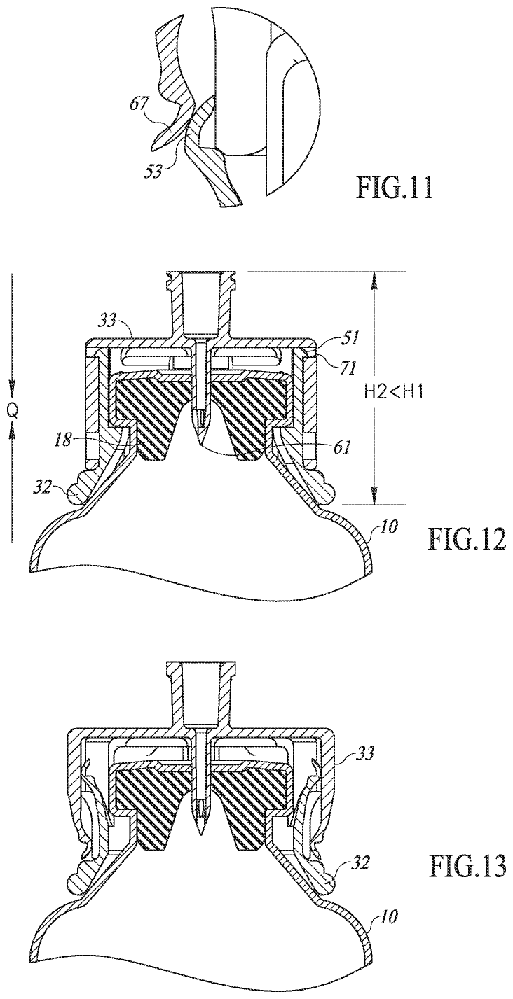

FIG. 11 shows the beginning of a subsequent manual linear sliding compaction for compacting the liquid drug transfer device 30A from its intermediate primed state towards its actuated state. The outward directed hook pair 67 contact the inward directed hook pair 53 thereby causing an instantaneous outwardly flexing of the flex member pair 66 and an instantaneous inward flexing of the flex member pair 44 until the inward directed hook pair 53 and the outward directed hook pair 67 pass each other whereupon the flex member pair 44 and flex member pair 66 revert to their non-flexed positions. The height difference H1−H2 equals the displacement the liquid source adapter 33 has to travel from its pre-actuated state in which the puncturing tip 61 overlies the uppermost injection port surface 19 to its actuated state in which the puncturing tip 61 protrudes through the injection vial stopper 18.

FIG. 12 and FIG. 13 show the liquid drug transfer device 30A in its actuated state after a complete manual compaction denoted Q. The user compaction releases the outward directed protrusion pair 51 from the extension limit aperture pair 69 such that they slide on the inside surface of the cap-like member 54 towards the securing aperture pair 71 and urges the puncturing tip 61 though the injection vial stopper 18 for flow communication with the injection vial 10. The outward directed protrusion pair 51 correspondingly snap into the securing aperture pair 71 in the actuated state thereby securing the actuated liquid drug transfer device 30A. The flex member pair 44 and the flex member pair 66 are correspondingly substantially co-extensive.

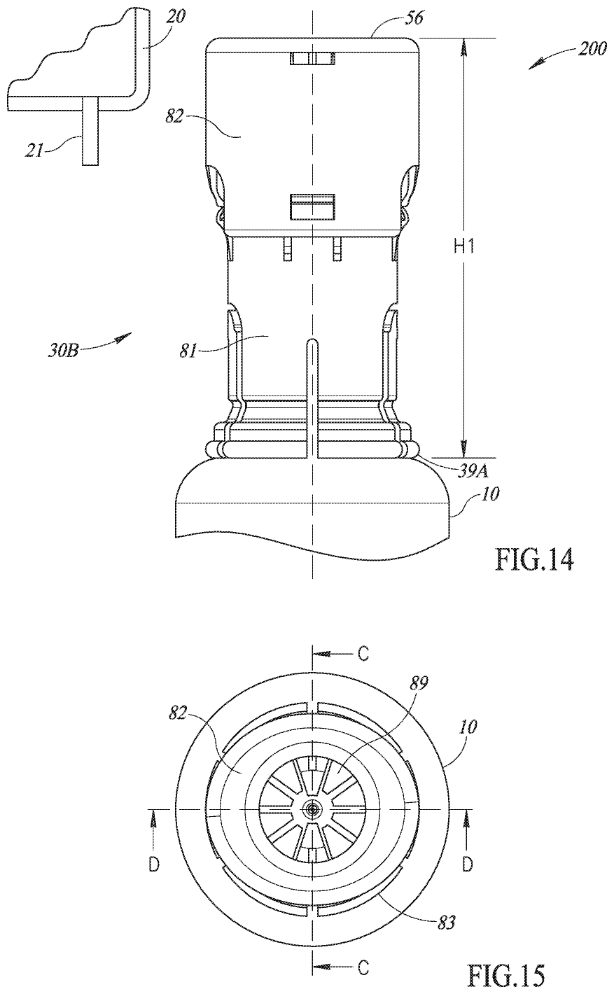

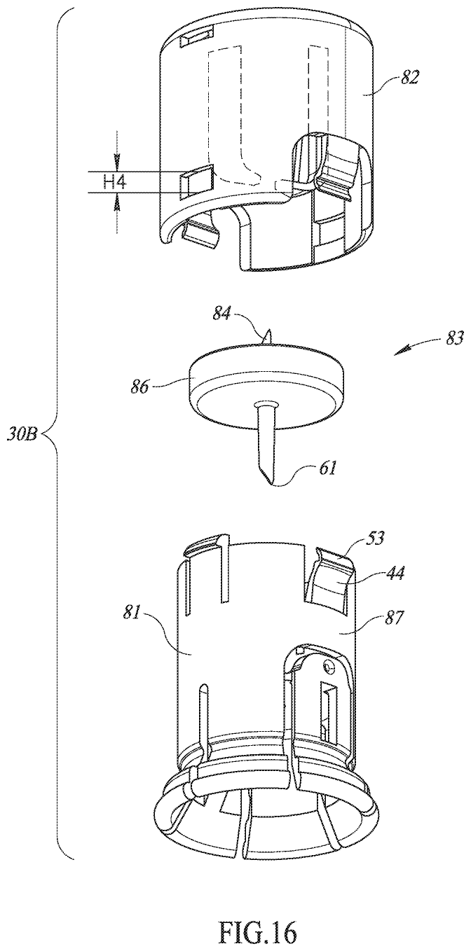

FIG. 14 to FIG. 16 show a RTU liquid drug transfer assemblage 200 including a liquid drug transfer device 30B having a similar construction as the liquid drug transfer device 30A and therefore similar parts are likewise numbered. The latter 30B differs from the former 30A insofar as it is intended to be used with a liquid source also requiring a puncturing action. The liquid source can be in the form of an infusion liquid source, and the like. The liquid drug transfer device 30B is shown implemented for flow connection with an infusion bag 20 having an injection port 21 and an administration port 22.

The liquid drug transfer device 30B includes a three component construction as opposed to the liquid drug transfer device 30A's two component construction. The liquid drug transfer device 30B includes an injection vial adapter 81, a liquid source adapter 82 and a discrete dual ended liquid transfer member 83 interdisposed between the injection vial adapter 81 and the liquid source adapter 82. The dual ended liquid transfer member 83 includes an upward liquid transfer member end 84 also terminating in a puncturing tip similar to the puncturing tip 61. The dual ended liquid transfer member 83 includes an intermediate circular flange 86.

The injection vial adapter 81 includes an upward sleeve 87 mounted on the injection vial adapter top surface 38 for supporting the circular flange 86 in the liquid drug transfer device 30B's pre-actuated state and the intermediate primed state. The upward sleeve 87 is formed with the diametric flex member pair 44 formed with the inward directed hooks 53 and the diametric flex securing member pair 48.

The liquid source adapter top surface 56 is formed with an injection port connector 89 for slidingly receiving the injection port 21 and a diametric inward directed injection port stopper pair 91 for stopping the insertion of the injection port 21 therein. The upward liquid transfer member end 84 underlies the injection port 21 in the liquid drug transfer device 30B's pre-actuated state.

The liquid drug transfer device 30B has a pre-actuated height H1, an actuated height H2 and an intermediate primed height H3 similar to the liquid drug transfer device 30A. The heights are indicated between the liquid source adapter top surface 56 and the lowermost injection vial adapter skirt rim 39A. The height difference H1−H2 equals the displacement that the liquid drug transfer device 30B has to compact from its pre-actuated state in which the puncturing tip 61 overlies the uppermost injection port surface 19 and the upward liquid transfer member end 84 underlies the injection port 21 to its actuated state in which the puncturing tip 61 protrudes through the injection vial stopper 18 and the upward liquid transfer member end 84 punctures through the injection port 21.

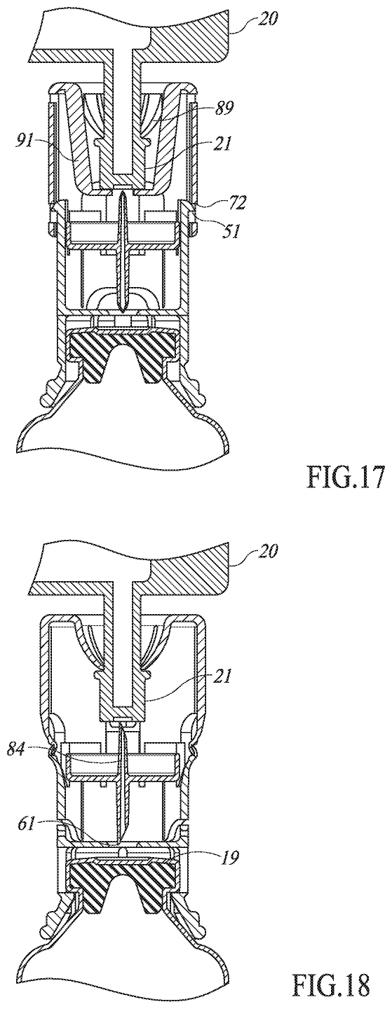

FIG. 17 to FIG. 22 show the use of the liquid drug transfer device 30B with an injection vial 10 and an infusion bag 20 is as follows:

FIG. 17 and FIG. 18 show the liquid drug transfer device 30B in a pre-actuated state at height H1. The puncturing tip 61 overlies the uppermost injection vial surface 19. The puncturing tip 84 underlies the injection port connector 21. The safety catch mechanism 34 prevents an inadvertent compaction. The outward directed protrusion pair 51 are deployed at the uppermost transverse rim pair 72.

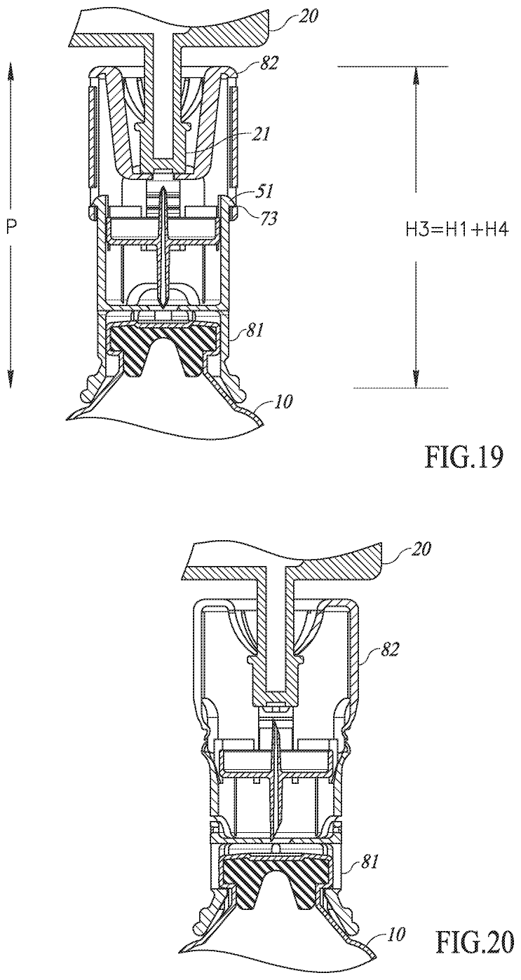

FIG. 19 and FIG. 20 show the liquid drug transfer device 30B in an intermediate primed state at height H3 after an initial manual linear sliding extension denoted P. The safety catch mechanism 34 is disengaged. The outward directed protrusion pair 51 stop against the lowermost transverse rim pair 73.

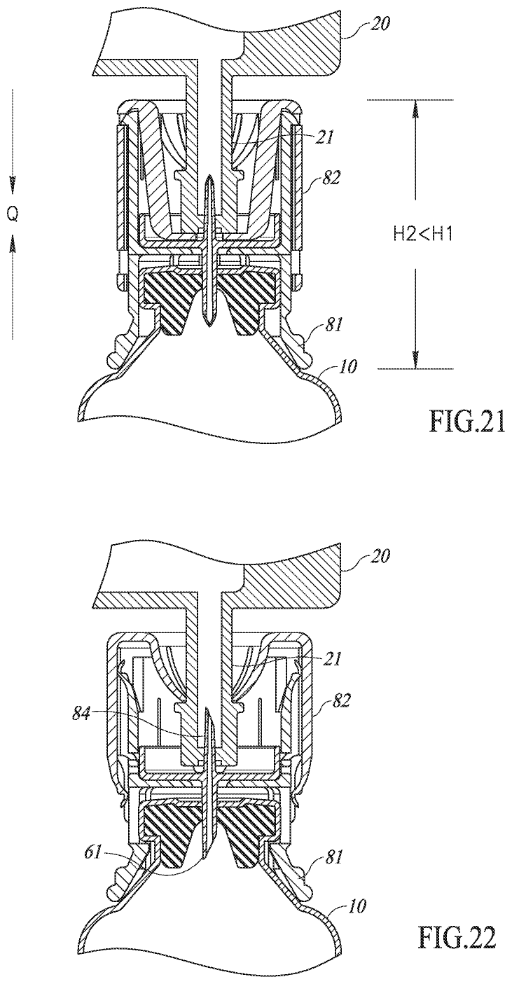

FIG. 21 and FIG. 22 show the liquid drug transfer device 30B in an actuated state at height H2 after a subsequent manual compaction denoted Q. The puncturing tip 61 punctures though the injection vial stopper 18 for flow communication with the injection vial 10. The puncturing tip 84 punctures the injection port 21 for flow communication with the infusion bag 20 thereby enabling flow communication between the infusion bag 20 and the injection vial 10. The outward directed protrusion pair 51 snap into the securing aperture pair 71.

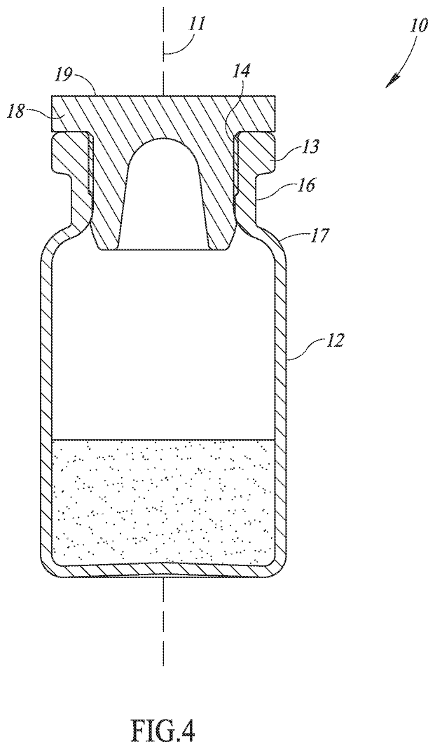

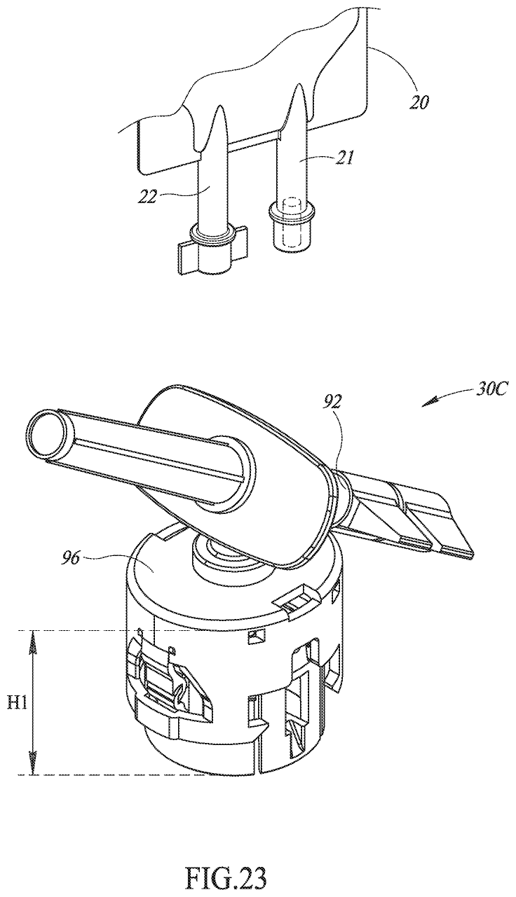

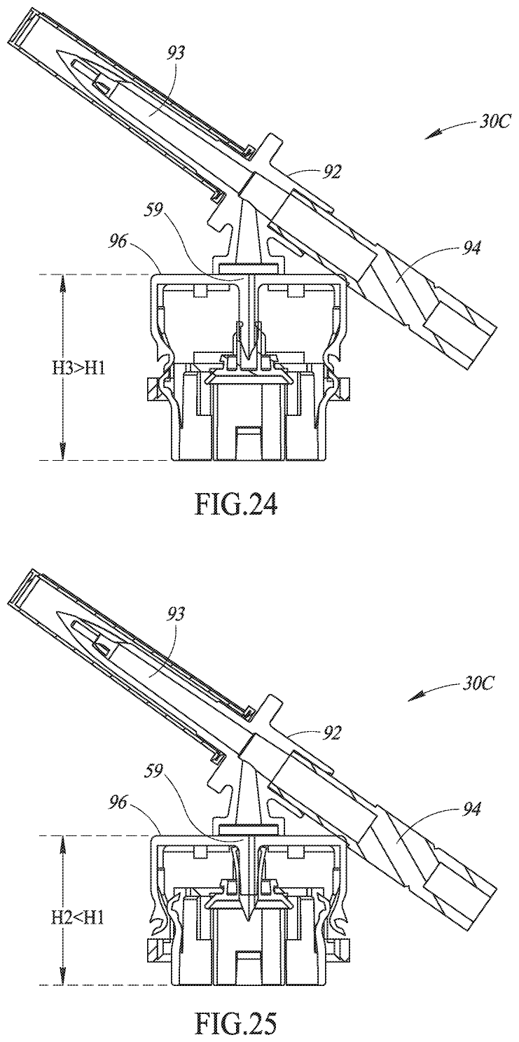

FIG. 23 to FIG. 25 show a liquid drug transfer device 30C also for use with the infusion bag 20. The liquid drug transfer device 30C has a similar construction and operation as the liquid transfer device disclosed in commonly owned PCT International Application No. PCT/IL2014/050680 entitled Liquid Transfer Devices for use with Infusion Liquid Containers and published under PCT International Publication No. WO 2015/019343 FIG. 4 and FIG. 5. The liquid drug transfer device 30C includes a trifurcated body 92 having an IV spike 93 for sliding sealed insertion into an infusion bag's administration port, a substitute IV port 94 for sliding sealed insertion of an infusion set and an integral vial adapter 96 constituted by the liquid drug transfer device 30A where the upward liquid transfer member end 59 is in continuous flow communication with the IV spike 93 and the substitute IV port 94.

While particular embodiments of the present invention are illustrated and described, it would be obvious to those skilled in the art that various other changes and modifications can be made without departing from the spirit and scope of the invention.

1. A user actuated liquid drug transfer device for use in a Ready-To-Use (RTU) liquid drug transfer assemblage for establishing flow communication between a liquid source and an injection vial, the injection vial including a closed end vial tube, and a tubular vial crown having a crown opening stopped by an injection vial stopper, the injection vial having an uppermost injection vial surface, the liquid drug transfer device having a longitudinal device centerline and comprising:
(a) an injection vial adapter having a transverse injection vial adapter top surface and a downward depending injection vial adapter skirt intended for telescopic mounting on the vial crown, said transverse injection vial adapter top surface including a transverse injection vial adapter top surface aperture along the longitudinal device centerline overlying the uppermost injection vial surface on said telescopic mounting on the injection vial;
(b) a liquid source adapter intended for attachment to the liquid source, said liquid source adapter including a transverse liquid source adapter top surface and a downward depending liquid source adapter skirt mounted on said injection vial adapter in a pre-actuated state of the liquid drug transfer device and configured for telescopically receiving said injection vial adapter therein in an actuated state of the liquid drug transfer device on user compaction of the liquid drug transfer device from said pre-actuated state to an actuated state;
(c) a dual ended liquid transfer member having an upward liquid transfer member end for flow communication with the liquid source and a downward liquid transfer member end in flow communication with said upward liquid transfer member end and terminating in a puncturing tip for puncturing the injection vial stopper for flow communication with the vial tube, said puncturing tip overlying the uppermost injection vial surface in said pre-actuated state and puncturing through the injection vial stopper in said actuated state;
(d) a safety catch mechanism requiring an initial manual linear sliding extension for extending said liquid source adapter from said injection vial adapter for priming the liquid drug transfer device to an intermediate primed state, thereby enabling said user compaction from said pre-actuated state to said actuated state;
(e) an extension limit arrangement for limiting said linear sliding extension of said liquid source adapter from said vial injection adapter in said intermediate primed state; and
(f) a snap fit securing arrangement for securing said liquid source adapter on said injection vial adapter in said actuated state.

2. The device according to claim 1 wherein said safety catch mechanism having at least one safety catch each constituted by said liquid source adapter having a downward depending resiliently flexible longitudinal directed flex member terminating at an outward directed hook and said injection vial adapter having an upward resiliently flexible longitudinal directed flex member terminating at an inward directed hook, said outward directed hook engaging said inward directed hook in said pre-actuated state, said outward directed hook being disengaged from said inward directed hook in said intermediate primed state and said outward directed hook sliding past said inward directed hook on compaction of the liquid drug transfer device from said intermediate primed state to said actuated state wherein said downward depending resiliently flexible longitudinal directed flex member and said upward resiliently flexible longitudinal directed flex member are substantially co-extensive in said actuated state.

3. The device according to claim 1 wherein said injection vial adapter includes a longitudinal directed flex member with an outward directed protrusion, said liquid source adapter skirt includes a longitudinal directed elongated extension limit aperture disposed remote from said liquid source adapter top surface and a securing aperture disposed adjacent said liquid source adapter top surface, said outward directed protrusion engaging said extension limit aperture for limiting said extension of said liquid source adapter from said injection vial adapter in said intermediate primed state and said outward directed protrusion engaging said securing aperture for securing said liquid source adapter on said injection vial adapter in said actuated state.

4. The device according to claim 1 for use with a male connector and wherein said liquid source adapter is integrally formed with said dual ended liquid transfer member and said upward liquid transfer member end is constituted by an access transfer port for flow communication with the male connector.

5. The device according to claim 1 for use with an infusion bag having an injection port and wherein said dual ended liquid transfer member is a discrete component interdisposed between said injection vial adapter and said liquid source adapter and said dual ended liquid transfer member terminates in a second puncturing tip constituting said upward liquid transfer member end for puncturing the injection port in said actuated state.

6. The device according to claim 1 for use with an infusion bag having an administration port and wherein the liquid drug transfer device includes a trifurcated body having an IV spike for sliding sealed insertion into the infusion bag's administration port, a substitute IV port for sliding sealed insertion of an infusion set, and said liquid source adapter,
said liquid source adapter being integrally formed with said dual ended liquid transfer member and said upward liquid transfer member end being in continuous flow communication with said IV spike and said substitute IV port.

7. A Ready-To-Use (RTU) liquid drug transfer assemblage including a liquid drug transfer device according to claim 1.
